(19) United States
(12) Patent Application Publication
(10) Pub. No.: US 2015/0074989 A1
(43) Pub. Date: Mar. 19, 2015

(54) HYDROPHOBIC-CAGE STRUCTURED MATERIALS IN ELECTRODES FOR MITIGATION AND EFFICIENT MANAGEMENT OF WATER FLOODING IN FUEL/ELECTROCHEMICAL CELLS

(71) Applicant: University of Houston System, Houston, TX (US)

(72) Inventor: Anima Bose, Houston, TX (US)

(73) Assignee: University of Houston System, Houston, TX (US)

(21) Appl. No.: 14/490,383

(22) Filed: Sep. 18, 2014

Related U.S. Application Data
(60) Provisional application No. 61/879,412, filed on Sep. 18, 2013.

(51) Int. Cl. H01M 4/88

(52) U.S. Cl. CPC H01M 4/8828; H01M 4/8807; H01M 4/8882
USPC 29/623.5; 427/115; 427/600

(57) ABSTRACT

Methods of making electrodes that mitigate water flooding, wherein the porous electrodes are made of hydrophobic cage structured materials that repel water, and provide for mechanisms that reduce water flooding.

### CROSS-REFERENCE TO RELATED APPLICATIONS

This U.S. Non Provisional Application herein claims priority to U.S. Provisional Application 61/879,412, filed Sep. 18, 2013, which is incorporated herein in its entirety.

### STATEMENT REGARDING FEDERALLY SPONSORED RESEARCH OR DEVELOPMENT

This invention was made with government support under Grant No. 10EE0003666 awarded by the Department of Energy. The United States government has certain rights in the invention.

### BACKGROUND

1. Field of the Disclosure

This disclosure generally relates to methods of making membrane electrode assembles (MEA's) that mitigate water flooding. More particularly, this disclosure is drawn to methods of making electrodes comprising hydrophobic cage structured materials that repel water, thereby mitigating the effect of water flooding, and further to composite materials such as those comprising hydrophobic cage structured materials that repel water thereby mitigating water flooding and therefore comprise such electrodes.

2. Background of the Technology

The efficiency and ability of fuel cells to function (such as, but not limited to proton electric cells) are greatly effected by the generation of water as a by-product of the electrochemical reaction that occurs within the cell. The ability of a fuel cell to function maybe effected by the relative humidity within the cell. For example, in proton electric cells the proton exchange membrane (PEM) must maintain an optimal level of humidity to hydrate protons and allow their transport across the membrane, whilst limiting the amount of water droplets within the membrane which cause disruptive swelling of the membrane itself.

Another and equally catastrophic effect of water within a fuel cell is water flooding, whereby the production of water (as described above) floods the cellular electrodes and blocks for example the gas diffusion channels of the cell thereby severely impeding or inhibiting the flow of reactants (ions and electrons) and drastically reducing the electric current produced or indeed even terminating current production. While some methods of addressing the control of humidity within the PEM has been discussed in the prior art (see for example US Patent Application 2012/0312695 (incorporated herein in its entirety)) the need to mitigate water-flooding remains unmet, therefore a method of mitigating water flooding in fuel cells, such as a proton electric fuel cell would be well received in the art, and satisfy such a need.

The Proton Exchange Membrane Fuel Cells (PEMFCs) as illustrated in FIG. 1, and currently known in the art, utilize oxygen and hydrogen to generate electrical power and produce water through a simple chemical reaction (Reaction 1), where the oxygen is reduced to water in the fuel cells, and is then drained from the device as the product.

O₂+4H⁺+4e→H₂O Reaction 1:

To maintain efficient performance in such electrochemical devices, water must be removed from the device as it is produced, because retention of water causes blockage of the reactants flow, thus resulting in a decrease in performance of the cell due to the insufficient availability of reactants.

Some of the water molecules produced will block the pores of the catalyst layer and gas diffusion layers (GDL's) that comprise the electrode, and reduce the efficiency of the flow of gases through these layers that is vital to maintaining the catalytic activity of the electrodes. Thus the PEMFC's currently used in the art, experience pore blockage which results in a decrease in the supply of the reactant and reduces mass transport, thereby impeding the vital oxygen reduction reaction (ORR) at the cathode.

Secondly, at the anode, the PEMFCs hydrogen is oxidized to protons (via the hydrogen oxidation reaction (HOR) of Reaction 2)):

H₂→2H⁺+2e Reaction 2:

and are thus transported through the conducting membranes, and the ionomer in the electrodes allowing for the transportation of the proton to and from the bulk electrolyte. The membranes and ionomer in electrodes usually contain sulfonic acids or other acids through which protons are shuttled via deprotonated anions. To maintain efficient proton conductivity, the ionomer in membranes and electrodes need to be hydrated. However, too much hydration reduces their conductivity, which also decreases the fuel cell performance.

A third issue experienced with currently known fuel cells is the reversal of the electrochemical reaction, i.e., instead of reducing oxygen at the cathode, H⁺ of water may instead be reduced at the cathode in Reaction 3:

2H₃O⁺+2e=H₂+2H₂O

thereby resulting in a total shutdown of the power generating device. In these extreme cases, the electrode reactions generate 0 Volts.

Therefore, it is clear that the amount of water retained in such electrochemical devices during operation must be critically balanced, and conventional methods and processes are relatively inefficient at doing so, thus such conventional cells are prone to water flooding and new cells are sort that display higher durability, withstand high current, and deliver higher power after prolonged use without reducing proton conductivity, each of which are diminished water flooding.

### BRIEF SUMMARY OF THE DISCLOSED EMBODIMENTS

The disclosure herein therefore provides for (1) an electrode comprising a composite material (a polymer comprising a hydrophobic cage-structure) that mitigates water flooding, and (2) a method of making (fabricating) such an electrode, (3) a method of mitigating water flooding in a fuel cell. An embodiment herein disclosed describes a method of making an electrode that mitigates water flooding comprising: mixing a hydrophobic cage structured material with a solvent, and adding to a first polymer to form a first polymer mixture; mixing a carbon support metal catalyst, and at least a first polymer mixture to form a second mixture; mixing the second mixture to form a catalyst ink; spraying the catalyst ink at a first catalyst loading onto a gas diffusion layer (GDL), wherein said gas diffusion layer may be optionally treated with a hydrophobic material; and Drying said catalytic ink onto said GDL to form an electrode, wherein said electrode mitigates water flooding. In some embodiments, the electrode is porous, and comprises said hydrophobic cage material, wherein said material is dispersed throughout the electrode to reduce water flooding in said electrode. In some embodiments herein described the hydrophobic cage structured material (HCSM) is a silsesquioxane compound; in other embodiments the hydrophobic cage structured material is OSP. In further embodiments the solvent is THF, in other embodiments first polymer is an ionomer, and in some further embodiments the first polymer is Nafion.

In some embodiments herein described of the method of making an electrode, the metal catalyst is a precious metal catalyst, a non-precious metal catalyst, in other embodiments the catalyst is Pt, in another embodiment the catalyst loading is about between 0.1 and 0.5 mg Pt/cm², about 0.25 mg Pt/cm², and in a further embodiment the catalyst loading is about 0.20 mg Pt/cm².

In another embodiment of a method of making an electrode described herein, the catalyst ink comprises: about 1% to about 50% Pt/C; and about 1% to about 80% of said first polymer mixture, wherein said first polymer mixture comprises, 1% to 99% wt of said first polymer and about 1% to about 99% wt of said hydrophobic cage structured material.

In another embodiment of a method of making an electrode described herein, the catalyst ink comprises: about 20% Pt/C; and about 20% of said first polymer mixture, wherein said first polymer mixture comprises, 97% wt of said first polymer and about 3% wt of said hydrophobic cage structured material. In another embodiment of a method of making an electrode described herein, the drying is by air, at about 130 degrees Celsius for about 1 hr, and in a further embodiment of a method of making an electrode described herein, the mixing of said ink comprises: stirring for about 30 minutes; sonicating for about 1 to 60 minutes; and further stirring for about 1 to 60 minutes; in another embodiment the mixing of said ink comprises: stirring for about 30 minutes; sonicating for about 30 minutes; and further stirring for about 30 minutes.

In an embodiment of a method of making an apparatus comprising and electrode described herein, the electrode comprises a hydrophobic cage structured material, and wherein the method comprises: mixing a hydrophobic cage structured material with a solvent, and adding to a first polymer to form a first polymer mixture; mixing a metal catalyst and a carbon support, and at least a first polymer mixture to form a second mixture; mixing the second mixture to form a catalyst ink; spraying the catalyst ink at a first catalyst loading onto at a first gas diffusion layer to form a first catalyst layer of a first electrode; spraying the catalyst ink at a second catalyst loading optionally different from the first catalyst loading, onto at second gas diffusion layer side to form a second catalyst layer of a second electrode; and assembling said first and said second electrodes with a membrane layer to comprise an membrane electrode assembly, wherein the first and second electrode mitigates water flooding. Further in some embodiments, the apparatus performance is improved compared to apparatus without a hydrophobic cage-structured polymer, in another embodiment described herein said electrode may comprise a membrane electrode assembly; or a fuel cell.

The present disclosure further addresses the issues detailed above by describing methods of making membrane electrode assembles (MEA's) that mitigate water flooding, wherein such MEA's comprise porous electrodes which further comprise hydrophobic cage-structured materials that repel water, and thereby mitigate water flooding in for example fuel/electrochemical cells. In some embodiments said electrodes comprise a catalytic layer (comprising HCSM and a catalyst) and a GDL; which are further assembled in some embodiments as shown by the figures herein presented.

In an exemplary embodiment of the invention a method of making a membrane electrode assembly [MEA] that mitigates water flooding comprises mixing a hydrophobic cage structured material with a solvent, and adding to a first polymer to form a first polymer mixture; mixing a carbon support metal catalyst, and at least a first polymer mixture to form a second mixture; sonicating the second mixture to form a catalyst ink; spraying the catalyst ink at a first catalyst loading onto at a first side of a preformed membrane to form a first catalyst layer of a catalyst coated membrane (CCM); spraying the catalyst ink at a second catalyst loading optionally different from the first catalyst loading, onto a second and opposite side of the CCM to form a membrane electrode assembly (MEA); and hot pressing a gas diffusion layer (GDL) on both the first side and the second side of the membrane electrode assembly (MEA), wherein the MEA mitigates water flooding during operation.

In one embodiment of the method of making a membrane electrode assembly that mitigates water flooding, at least a first electrode layer (EL) of the MEA is porous, and comprises the hydrophobic cage material, wherein the material is dispersed throughout the MEA to reduce water flooding in the electrode layer (EL), the GDL, and gas-flow-channels (GFCs); in another embodiment the hydrophobic cage structured material is a silsesquioxane compound, and in a further embodiment the hydrophobic cage structured material is OSP.

In one embodiment of the method of making a membrane electrode assembly that mitigates water flooding, the solvent is THF; in another embodiment the first polymer is an ionomer; in a further embodiment the first polymer is Nafion; and in a further embodiment the metal catalyst is Pt.

In one embodiment of the method of making a membrane electrode assembly that mitigates water flooding, the first catalyst loading is about 1 μg Pt/cm² to about 1 g Pt/cm²; in a further embodiment, the first catalyst loading is about 0.2 mg Pt/cm², in another embodiment the first catalyst loading it is about 100 μg Pt/cm². In one embodiment of the method of making a membrane electrode assembly that mitigates water flooding, the second catalyst loading is about 1 μg Pt/cm² to about 1 g Pt/cm²; in a further embodiment, the second catalyst loading is about 0.25 mg Pt/cm², in another embodiment the second catalyst loading it is about 100 μg Pt/cm².

In one embodiment of the method of making a membrane electrode assembly that mitigates water flooding, the catalyst ink comprises about 20% Pt/C; and about 20% of the first polymer mixture, wherein the first polymer mixture comprises, 97% wt of the first polymer and about 3% wt of the hydrophobic cage structured material. In another embodiment the membrane is an ionomer comprising at least 97% Nafion; in another embodiment, the membrane further comprises 3% wt of a hydrophobic cage structured material; in a further embodiment the membrane is porous, and in a still further embodiment the CCM are porous.

In one embodiment of the method of making a membrane electrode assembly that mitigates water flooding, the MEA comprises a porous CCM and a porous membrane, wherein the porous CCM and porous membrane comprises a hydrophobic cage structured polymer, which repels H₂O formed within the MEA thereby mitigating water flooding of the MEA.

In one embodiment of a method of making an apparatus comprising a MEA disclosed herein, the MEA comprises a hydrophobic cage structured material, wherein the method comprises mixing a hydrophobic cage structured material with a solvent, and adding to a first polymer to form a first polymer mixture; mixing a metal catalyst and a carbon support, and at least a first polymer mixture to form a second mixture; sonicating the second mixture to form a catalyst ink; wherein sonicating may be from 1 sec to 1 hr, and in some embodiments may be about 8 minutes to about 10 minutes; spraying the catalyst ink at a first catalyst loading onto at a first side of a preformed membrane to form a first catalyst layer of a catalyst coated membrane (CCM); spraying the catalyst ink at a second catalyst loading optionally different from the first catalyst loading, onto at a second side of a preformed membrane to form a second catalyst layer of a catalyst coated membrane (CCM); hot pressing a first gas diffusion layer (GDL) with the first catalyst layer of a CCM to form a first electrode of a membrane electrode assembly; and hot pressing a second gas diffusion layer (GDL) with the second catalyst layer of a CCM to form a second electrode of a membrane electrode assembly, wherein the MEA mitigates water flooding; in another embodiment the apparatus comprises either a porous membrane; a porous CCL; or both, and thereby mitigates water flooding; and in a further embodiment the apparatus performance is improved compared to apparatus without a hydrophobic cage-structured polymer.

In one embodiment a method of making a hydrophobic membrane is disclosed, wherein the method comprises mixing a hydrophobic cage structured material with a solvent, and adding to a first polymer to form a first polymer mixture; and forming a membrane structure, wherein the hydrophobic membrane mitigates water flooding.

Further embodiments of the disclosure provide for a membrane electrode assembly (MEA) that mitigates water flooding, comprising: a porous membrane, wherein said membrane comprises a first polymer, and a hydrophobic cage structured material, and wherein said membrane repels water thereby mitigating water flooding in said MEA. In some embodiments the MEA further comprise at least a first catalyst layer, in further embodiments the catalyst layer comprises a hydrophobic cage structured material.

In some embodiments of the MEA, the hydrophobic cage structured material comprises a cage-structured siloxane; in a further embodiment the cage-structured siloxane comprises Octasiloxane Poss (OSP).

In some embodiments of the membrane electrode assembly, the first polymer is an ionomer, in a further embodiment the ionomer is Nafion™, and in some embodiments of the membrane electrode assembly the catalyst comprises Pt. In another embodiment herein described, a porous membrane electrode assembly (MEA) that mitigates water flooding by repelling water, made by comprises mixing a hydrophobic cage structured material with a solvent, and adding to a first polymer to form a first polymer mixture; mixing a carbon support metal catalyst, and at least a first polymer mixture to form a second mixture; sonicating the second mixture to form a catalyst ink; spraying the catalyst ink at a first catalyst loading onto at a first side of a preformed membrane to form a first catalyst layer of a catalyst coated membrane (CCM); spraying the catalyst ink at a second catalyst loading optionally different from the first catalyst loading, onto a second and opposite side of the CCM to form a membrane electrode assembly (MEA); and hot pressing a gas diffusion layer (GDL) on both the first side and the second side of the membrane electrode assembly (MEA), wherein the MEA mitigates water flooding during operation.

In an embodiment the membrane electrode assembly (MEA) herein described comprises a electrochemical cell, in another embodiment the cell withstands high current, as compared to conventional cells which do not contain a hydrophobic cage-structured material, in a further embodiment the cell delivers higher power over prolonged use without reduction of proton conductivity, as compared to conventional cells which do not contain a hydrophobic cage-structures siloxane polymer; and in a still further embodiment the of electrochemical cell the MEA exhibits reduced water flooding as compared to conventional cells which do not contain a hydrophobic cage-structured material. In a further embodiment of the membrane electrode assembly herein described, the porous membrane comprises a pore size optimized for free flow of reactants and products within a cell. In embodiments herein described, HCSM may be used to fabricate an electrode of a fuel cell so that the hydrophobicity of the porous electrode reduces water flooding; in other embodiments the membrane of the MEA may comprise HCSM, and in further embodiment the MEA may be comprised of a membrane comprising HCSM and an electrode comprising HCSM, wherein flooding is reduced in the electrode, gas diffusion layers, and the proton exchange membrane itself.

### BRIEF DESCRIPTION OF DRAWINGS

For a detailed description of the disclosed exemplary embodiments of the invention, reference will now be made to the accompanying drawings, wherein:

FIG. 1(A-B) are schematic diagrams of functional PEMFC operated on hydrogen and oxygen as disclosed in the prior art;

FIG. 2(A-B) are Polarization curves of raw data, concentration-free, ohmic resistance-free and concentration-free, and power density curves: initial (2A) and after 250 hours dynamic stress testing (2B) of single cell employing FCD0a (containing 0 wt % OSP in electrodes) operated under normal conditions at 80° C., 80% RH, and 0.2/0.2 L/min H₂/O₂ at ambient pressure, in accordance with an embodiment of this invention;

FIGS. 3(A-B) are Polarization curves of raw data, concentration-free, ohmic resistance-free and concentration-free, and power density curves: initial (left) and after 250 hours dynamic stress testing (right) of single cell employing FCD8 (containing 3wt % OSP in electrodes) operated under normal conditions at 80° C., 80% RH, 0.2/0.2 L/min H₂/O₂ at ambient pressure, in accordance with an embodiment of this invention;

FIG. 4 depicts comparison of areal resistance and proton conductivity of membranes of FCD0a and FCD8 during 250 hours DST experiments. FCD0 is an MEA is identical in composition of FCD0a that failed after 48 hours of operation, in accordance with an embodiment of this invention;

FIG. 5 is a plot of the load profile used for the cell dynamic stress test (DST) for 250 hours testing generated from initial V-I data of FCD8, in accordance with an embodiment of this invention;

FIG. 6 is a plot of a DST experiment voltage profile as a function of time of FCD0a MEA under normal conditions at 80° C., 80% RH, 0.2/0.2 L/min H₂/O₂ at ambient pressure. Number inserted in plot is the current applied in Ampere by program, in accordance with an embodiment of this invention.

FIG. 7 is a plot of a current profile of DST cycling as a function of time of FCD0a MEA under normal conditions at 80° C., 80% RH, 0.2/0.2 L/min H₂/O₂ at ambient pressure. Number inserted in plot is the current applied in Ampere by program, in accordance with an embodiment of this invention;

FIG. 8 is a plot of a DST experiment voltage profile as a function of time of FCD8 MEA under normal conditions at 80° C., 80% RH, 0.2/0.2 L/min H2/O2 at ambient pressure. Number inserted in plot is the current applied in Ampere by program, in accordance with an embodiment of this invention;

FIG. 9, is a plot of a DST experiment current profile as a function of time of FCD8 MEA under normal conditions at 80° C., 80% RH, 0.2/0.2 L/min H2/O2 at ambient pressure. Number inserted in plot is the current applied in Ampere by program, in accordance with an embodiment of this invention;

FIG. 10(A-B) are photographs of flow-field (A) of hard-wear used in FCD0a (does not contain OSP) 250 hours DST measurement and GDL facing FCD0a (B) with drops of water in GDL pores and swollen membrane at the edge GDL. Photograph was taken immediately after disassembling the cell from 250 hours DST operation, in accordance with an embodiment of this invention;

FIG. 11(A-B) are photographs of flow-field (A) of hard-wear used in FCD8 (contains OSP) 250 hours DST measurement, and GDL facing FCD8 (B) with only few tiny drops of water standing on GDL. Photograph was taken immediately after disassembling the cell from 250 hours DST operation, in accordance with an embodiment of this invention;

FIG. 12, is a flow chart depicting a method of making a MEA in accordance with an embodiment of this invention;

FIG. 13 is a schematic depiction of a front and side view of an electrode in accordance with an embodiment of this invention;

FIG. 14 is a schematic depiction of a single fuel cell in accordance with an embodiment of this invention;

FIG. 15 is a schematic depiction of a catalyst coated membrane in accordance with an embodiment of this invention;

FIG. 16 is a schematic depiction of two configurations of MEA's in accordance with an embodiment of this invention;

FIG. 17 is a flow chart depicting a method of making catalytic ink comprising HCSM in accordance with an embodiment of this invention; and

FIG. 18 is a flow chart depicting a method of making an electrode comprising HCSM in accordance with an embodiment of this invention.

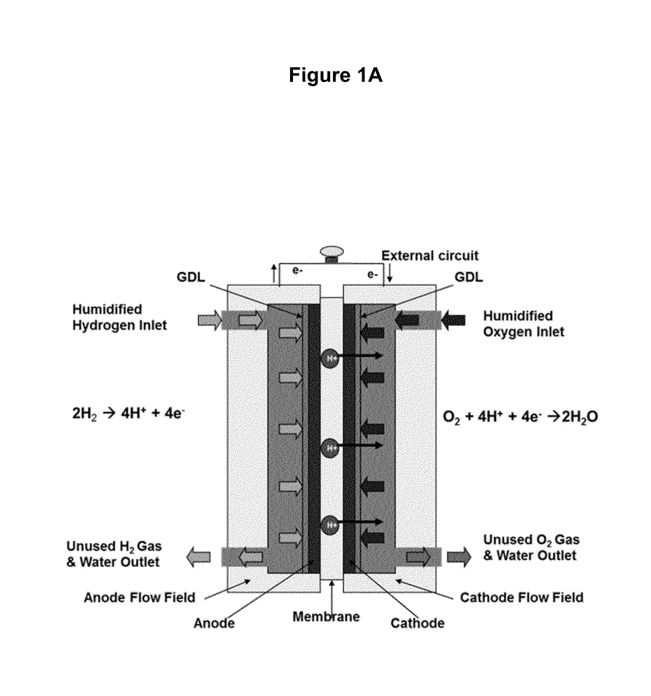

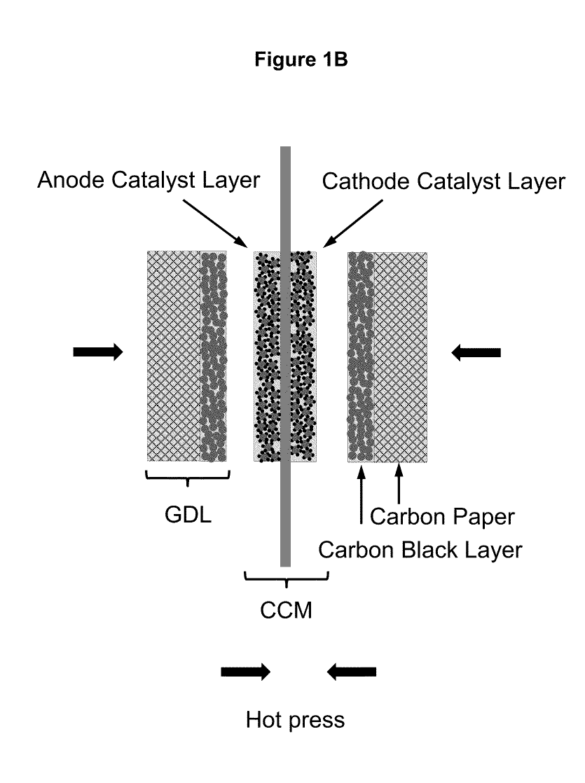

### DETAILED DESCRIPTION OF THE DISCLOSED EMBODIMENTS

The following discussion is directed to various exemplary embodiments of the invention. One skilled in the art will understand that the following description has broad application, and the discussion of any embodiment is meant only to be exemplary of that embodiment, and not intended to intimate that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” The term “substantially” generally means mostly, near completely, or approximately entirely. As used herein, the term “about,” when used in conjunction with a percentage or other numerical amount, means plus or minus 10% of that percentage or other numerical amount. For example, the term “about 80%,” would encompass 80% plus or minus 8%. Further, all publications and other references cited herein are incorporated in their entirety. As used herein a hydrophobic cage structured material may refer to any material, mixture, polymer or solution comprising OSP or equivalent structures, as recognised by one of ordinary skill.

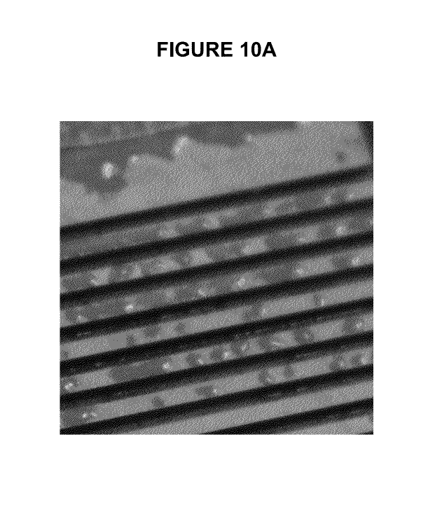

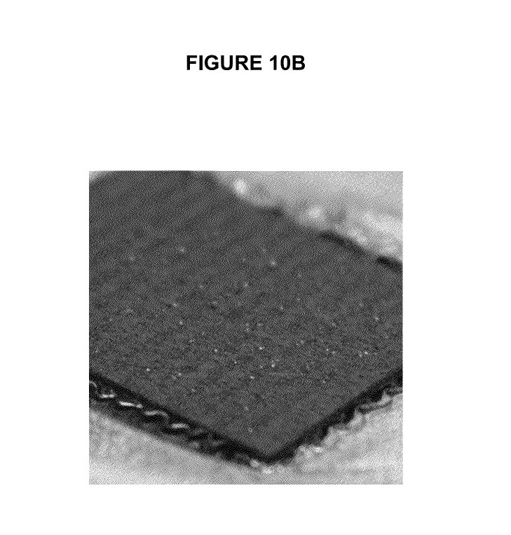

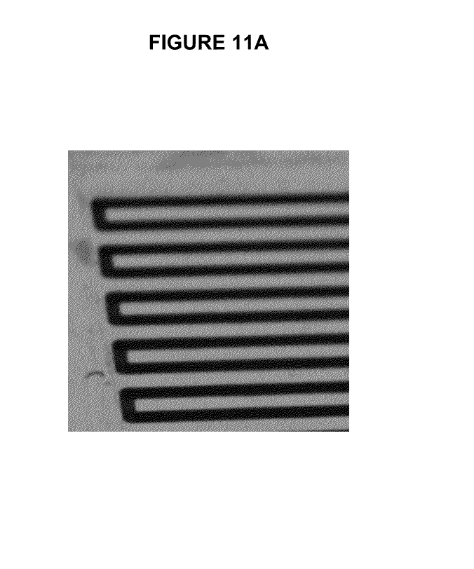

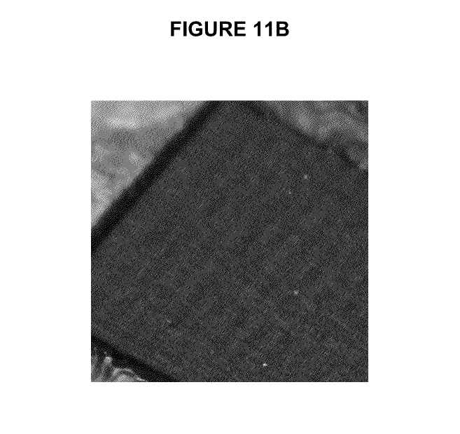

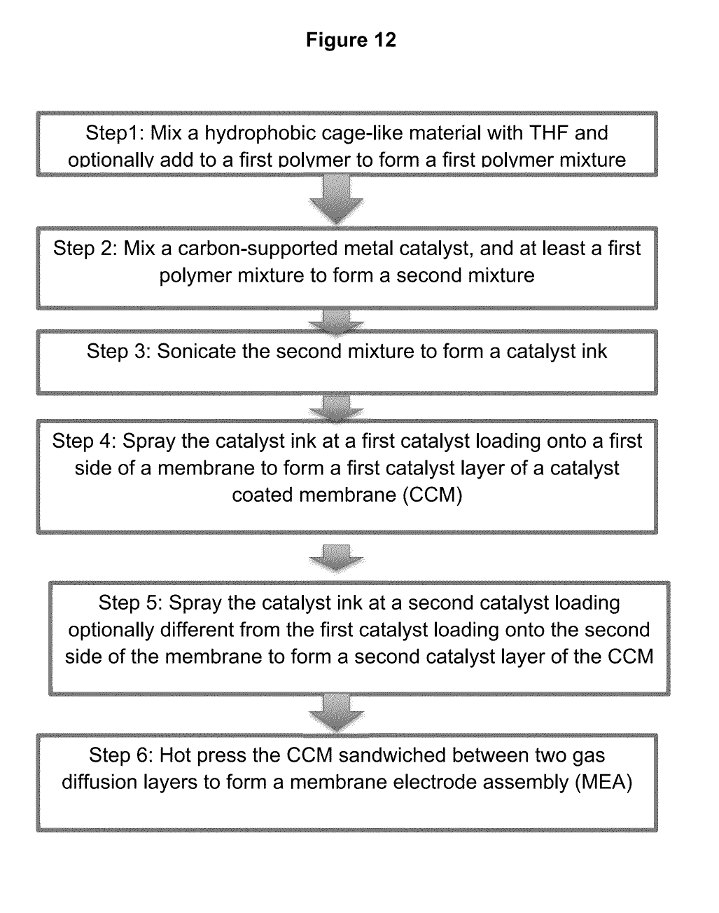

The present disclosure describes methods of making electrodes, and membrane electrode assembles (MEA's) that mitigate water flooding, wherein such MEA's comprise porous electrodes which further comprise hydrophobic cage-structured materials that repel water, and thereby mitigate water flooding in for example fuel/electrochemical cells. Further, the disclosure relates to methods of blending materials in a catalyst layer, and mechanisms to reduce water flooding. Thus, the disclosure more preferably relates to such methods of making electrodes and membrane electrode assemblies (MEAS) that incorporate a hydrophobic cage-structured materials such as a siloxane within the catalyst layer of fuel cell electrodes, wherein the hydrophobic material repels water thereby mitigating water flooding within for example the gas flow channels (GFC) of the MEA. In some embodiments the resulting MEA's (made by the methods described herein, as illustrated by the flow chart of FIG. 12) exhibit higher durability, withstand high current, and deliver higher power after prolonged use without reducing proton conductivity, this is achieved as a direct result of the reduction of water flooding (water mitigation), as compared to some electrodes known in the prior art. In some embodiments, these improved performances are attributed to the complete elimination of water flooding, and in some embodiments, to the significant reduction of ‘water flooding’, which is a phenomenon that limits power output and longevity of electrochemical devices. Furthermore, direct visible evidence of the lack of flooding is presented in FIGS. 10 and 11.

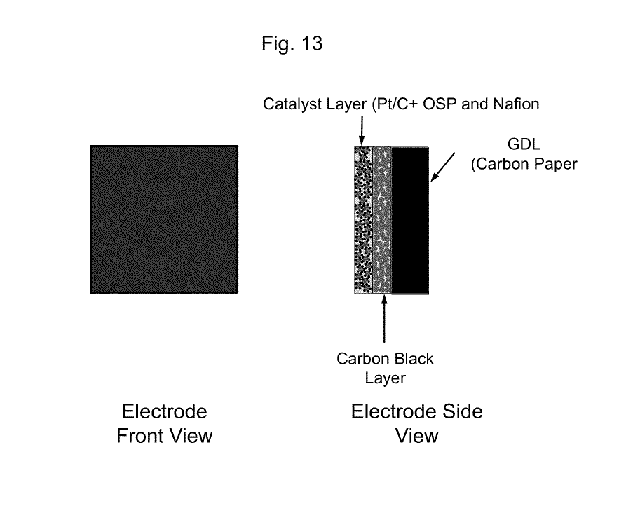

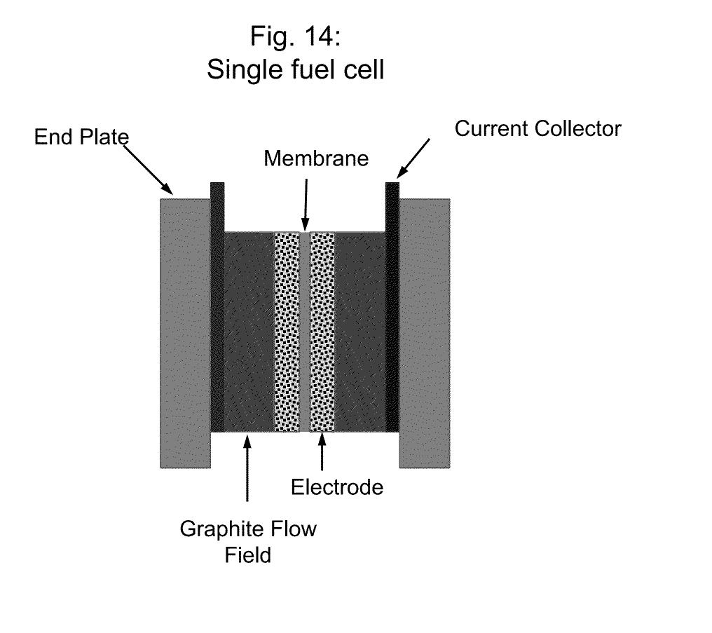

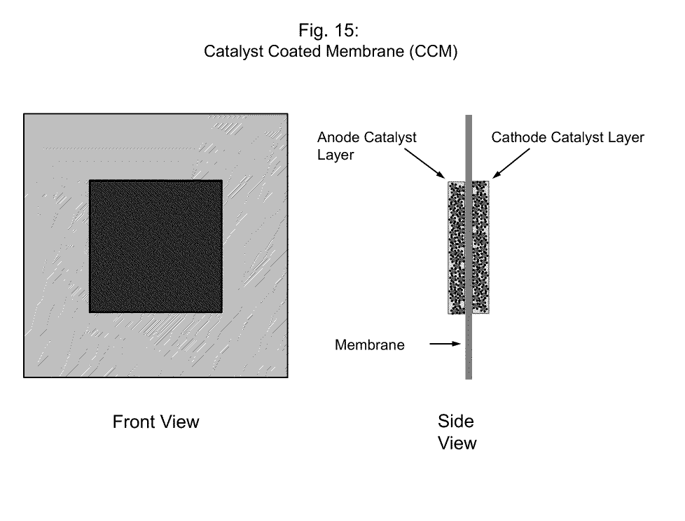

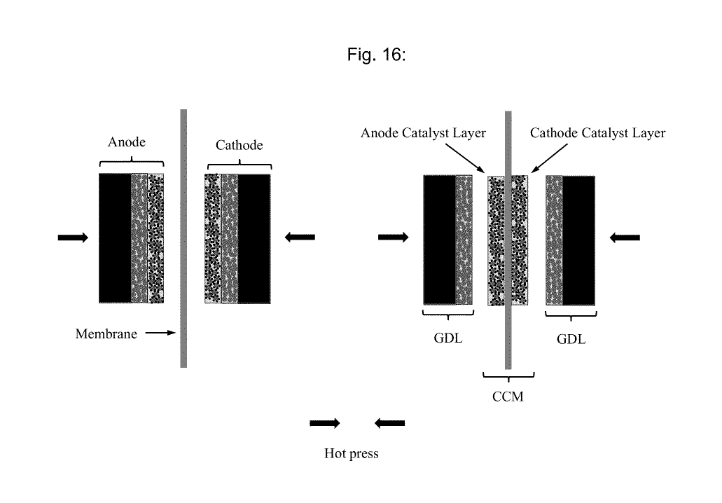

Methods of Making an Electrode that Mitigates the Effects of Water Flooding: the method of making an electrode (such as depicted in FIG. 13) that mitigates water flooding is herein described: wherein an embodiment for preparing electrodes, such as but not limited to cathode electrodes containing 5 wt. % OSP and 95 wt % Nafion (to comprise a hydrophobic polymer of 100 wt %) are herein described. In the electrode, the Pt catalyst loading is about 0.25 mg/cm² and the polymer loading is 40 wt. % (polymer and catalyst comprise 100 wt %).

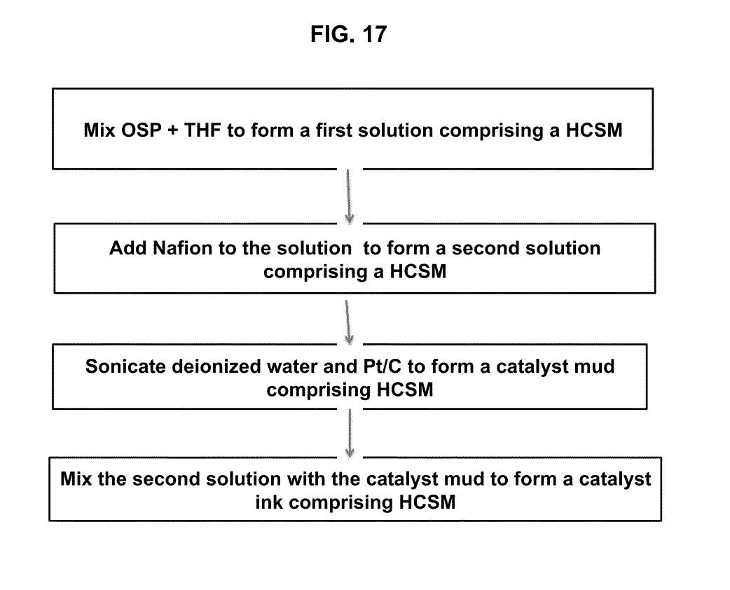

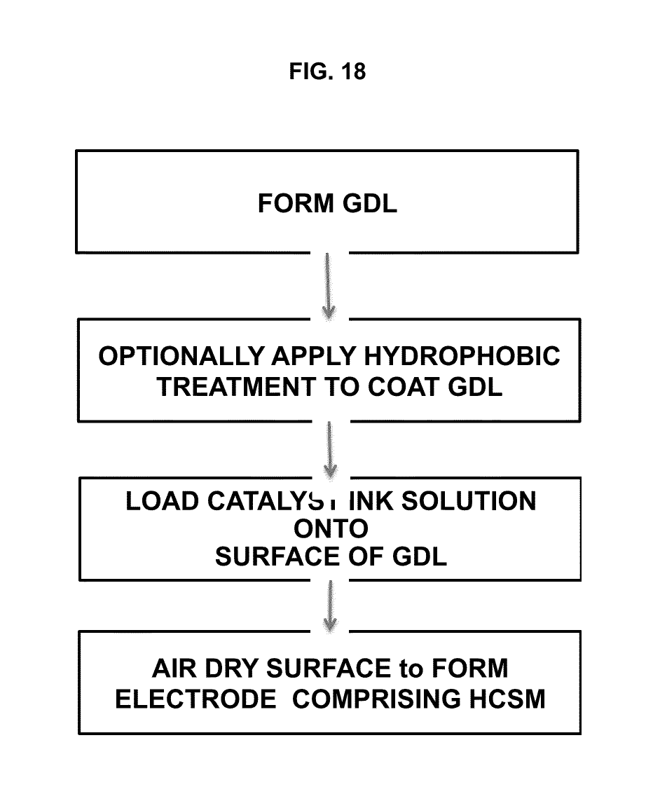

Several pieces of gas diffusion layer (GDL) with a desired geometry (2.25 cm×2.25 cm) were cut (FIG. 18). The GDL is a carbon paper, carbon cloth, or conductive porous sheet with one side coated with a carbon black layer. In some embodiments a hydrophobic treatment may be applied before use. Thus, in this example, the carbon paper coated with a carbon black layer on one side (SGL group 10 BC) was used as the GDL. Platinum nanoparticles were then loaded on to the carbon black (Pt/C, 20 wt %, Johnson Matthey, HiSPEC 3000) were used as the catalyst. An aliquot of 0.40 mL deionized water was slowly added to 62.5 mg Pt/C to wet the surface. The catalyst mud was sonicated for 30 second to make sure the catalyst wetted completely. An OSP tetrahydrofuran (THF) solution was prepared by adding 12 mg OSP into 10 mL (THF) and the solution was stirred for 15 min. 1.83 mL OSP/THF solution was then mixed with 0.95 mL Nafion dispersion (5 wt. %, DuPont, DE 521) in a vial and stirred for 15 min. The obtained OSP-Nafion/THF solution was added to the wetted catalyst while stirring (FIG. 17). The vial used for OSP-Nafion/THF solution was washed with 0.50 mL THF to transfer the residual Nafion resin to the catalyst ink. The catalyst ink was stirred for 30 min, sonicated for 30 min, and then stirred again for another 30 min before spray. In some embodiments it was found that the ink has to be used within about 6 h after preparation to avoid the degradation caused by aggregation of particles in the ink. The catalyst ink was then uniformly sprayed on the carbon black layer of the GDL by using a Badger® airbrush. During spraying, an infrared heat lamp (Sylvania, 250 W) was used to dry the sprayed ink on the GDL. The obtained electrode was finally dried at 130° C. in air for 30 min. The electrode is thus comprised on HCSM which imparts to the electrode a hydrophobic porosity, which allows the control or reduction of water flooding, thus reduction of the excess water in the pores of the GDL reduces pore blockage and thus allows the reactants to reach the catalysts' active sites, thus reducing the gas starvation and an drop in cell potential (current), that occurs during water flooding. Thus maintaining a more constant production of current by the cell.

Methods of Making a Membrane Electrode Assembly (MEA) that Mitigates the Effects of Water Flooding:

The method of making a MEA that mitigates water flooding is herein described, wherein a hydrophobic cage-like material is mixed with a solvent such as THF and is added to a first polymer (such as Nafion) to form a first polymer mixture, as per step 1 of the flow chart of FIG. 12.

In one embodiment of the invention, a hydrophobic cage-structures material is a silsesquioxane. Wherein the silsesquioxane compound may include an oligomeric silsesquioxane compound. An oligomeric silsesquioxane compound is a molecule of which the repeating unit has the formula RSiO3/2. The term “silsequi” refers to the ratio of the silicon and oxygen atoms, i.e., Si:O=1:1.5. An oligomeric silsesquioxane compound can have different molecular structure, such as random, ladder-like, cage and partial cage structures. In one embodiment, the oligomeric silsesquioxane is characterized by having a cage structure. Exemplary oligomeric silsesquioxanes include polyhedral oligomeric silsesquioxanes, which are also designated by the registered trademark POSS® (owned by Hybrid Plastics, Inc.). Generally the term “POSS” indicates the oligomeric silsequioxanes with a cage structure, even a partial one, and may have the general formula (RSiO3/2)n, where R denotes various monovalent group and n may range from 6 to 18. In one embodiment, R is HMe2SiO and n is equal to 8, which is a silsesquioxane compound that is commercially-available from Hybrid Plastics, Inc. as a solid and is sold under the tradename OctaSilane POSS®. The chemical structure of OctaSilane POSS® is shown in Formula 1.

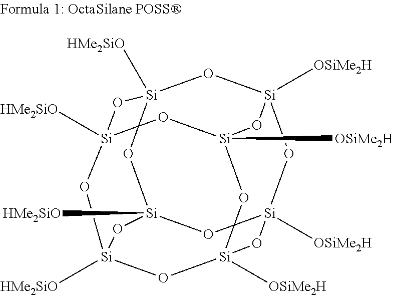

A carbon support metal catalyst was then mixed with the first polymer mixture to form a second mixture; and the second mixture was sonicated to form a catalyst ink. The catalyst ink was sprayed at a first catalyst loading onto at a first side of a preformed membrane to form a first catalyst layer of a catalyst coated membrane (CCM), as per steps 2-4 of FIG. 12. The catalyst ink was then sprayed at a second catalyst loading (optionally different from the first catalyst loading) onto at a second side of the preformed membrane to form a second catalyst layer of a catalyst coated membrane (CCM); a first gas diffusion layer (GDL) is hot pressed with the first catalyst layer of the CCM to form a first electrode of the MEA, and a second gas diffusion layer (GDL) is hot pressed with the second catalyst layer of the CCM to form the second electrode of the MEA as per steps 5-7 of FIG. 12.

An embodiment of such an MEA was produced using 3 wt % of Octasiloxane Poss (OSP) and 97% Nafion in both the membrane and catalyst layers; MEA's were also prepared without OSP (thus comprising 100% Nafion in the membrane and catalyst layers), and tested in single cells. Further, Nafion is a proton conducting polymer is a sulfonated tetrafluoroethylene-based fluoropolymer-copolymer. For example, the sulfonated tetrafluoroethylene-based fluoropolymer-copolymer may be ethanesulfonyl fluoride, 2-[1-[difluoro-[(trifluoroethenyl)oxy]methyl]-1,2,2,2-tetrafluoroethoxy]-1,1,2,2,-tetrafluoro-, with tetrafluoroethylene, which is commercially available from the E. I. du Pont de Nemours and Company, under the tradename Nafion®. Specifically, Nafion® is a perfluorosulfonic acid and polytetrafluoroethylene (PTFE) copolymer and is commercially-available as a chemically-stabilized dispersion that is in a solvent mixture predominantly comprised of water, propanol and ethanol. The proton conducting polymer, which is a species of an ionomer, is sandwiched between anode and cathode. The primary function of these membranes is to carry protons from the anode to the cathode. Suitable solvents required during the fabrication of the MEA's may include polar protic or polar aprotic solvents. For example, alkanols, such as butanol, propanol, ethanol, and methanol; amides, such as n-methylpyrrolidinone (NMP) or dimethylformamide (DMF); sulfoxides, such as dimethylsulfoxide (DMSO); ethers, such as tetrahydrofuran (THF) and diethyl ether (Et2O); chlorinated solvents, such as chloroform or dichloromethane (DCM); and the like may be used as solvents. The choice of solvent largely depends on the selections of the conducting polymer and the silsesquioxane compound. A catalyst may comprise a precious metal, semi-precious metal, or mixtures or alloys thereof. For example, in one embodiment of the method herein disclosed, a catalyst ink was prepared using 20% Pt/C (Vulcan XC-72, carbon support metal catalyst), and 20% Nafion D2021 (or 3% OSP in Nafion D3021 for MEA's fabricated to contain OSP) which were mixed and stirred for about half an hour, sonicated by horn sonication for about 10 minutes, and sprayed onto both sides of the membranes (in some embodiments, opposite ends of the membranes), wherein the given % OSP in the catalyst ink, was first dissolved in Tetrahydrofuran (THF) and added into a commercial Nafion solution and mixed/stirred for 30 mins until solution was translucent, and used as the ionomer as described above. Catalyst loadings for anode and cathode were 0.2 and 0.25 mg Pt/cm2, respectively. SGL 10BC was used as Gas diffusion layer (GDL), and hot-pressed with the catalyst coated membrane (CCM) at 145° C., 2500 lb for 5 cm2 of MEA active area. The two MEA's were then used in comparative studied described in the examples below, wherein the fuel cell labeled as FCD0a (contains no OSP) and FCD8 (contains 3% OSP of total ionomer, Nafion D3021).

Other embodiments of such MEA's may include other polymer/hydrophobic material combinations, where for example polymers comprising both OSP and Nafion may comprise the catalyst layer alone, while Nafion alone may comprise the membrane layer. Further the ratio of OSP (or any other suitable hydrophobic materials) may be combined in a suitable ratio to Nafion (or other polymer), for example 0.001 wt. % hydrophobic material to 99.999 wt. % Nafion, to 0.001 wt. % Nafion (or traditional membrane polymer) to 99.999 wt. % hydrophobic material.

The following examples of processing conditions and parameters are given for the purpose of illustrating certain exemplary embodiments of the present invention.

### EXAMPLES

The performance testing of embodiments of electrodes/MEA's comprising hydrophobic cage like materials and made by the methods herein described were conducted by measuring a number of different performance criteria, as illustrated below:

### Example 1

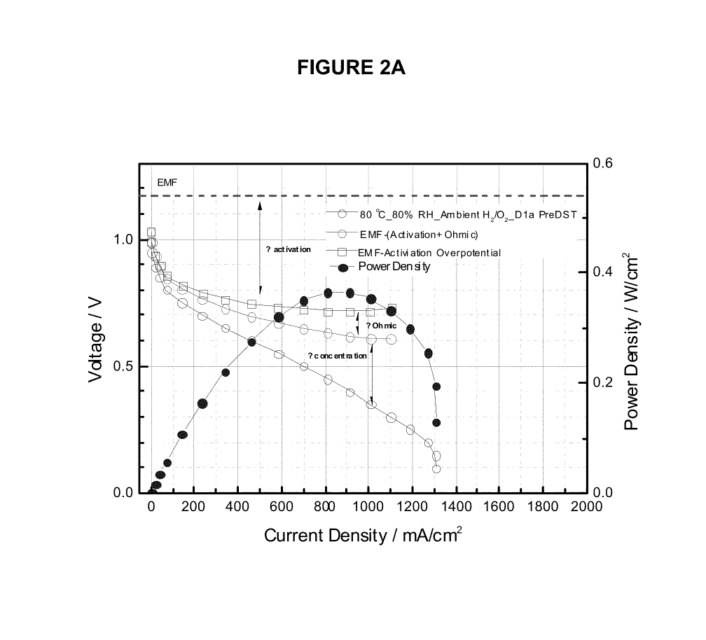

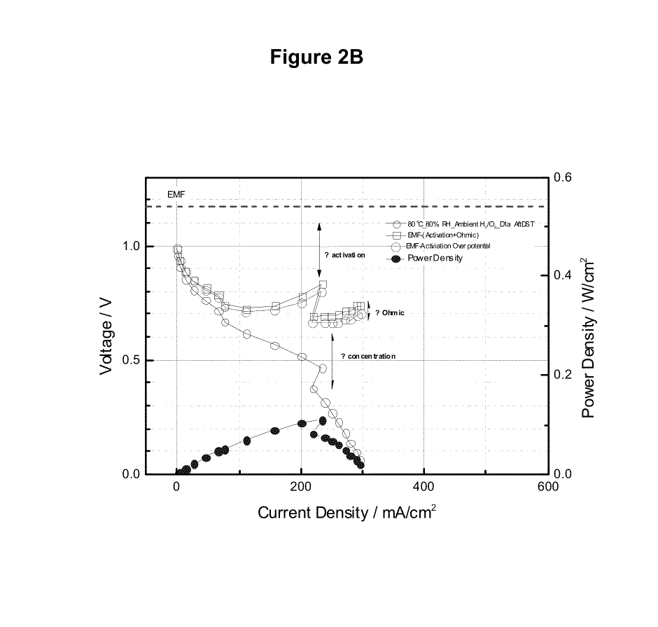

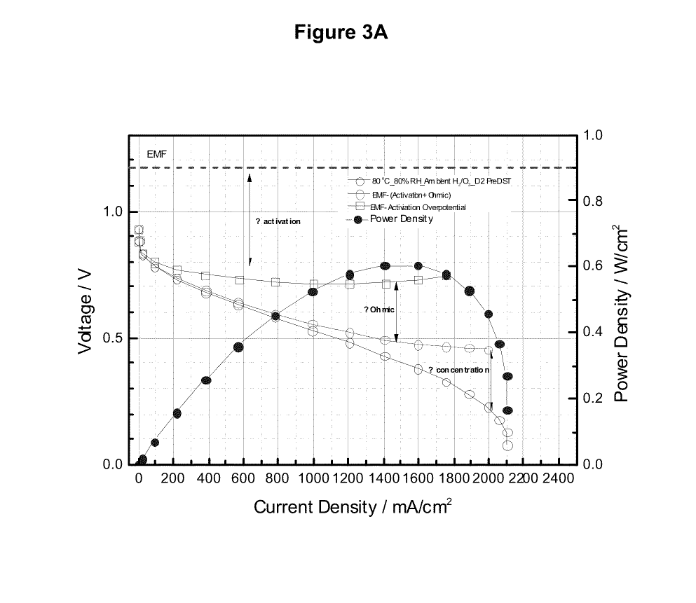

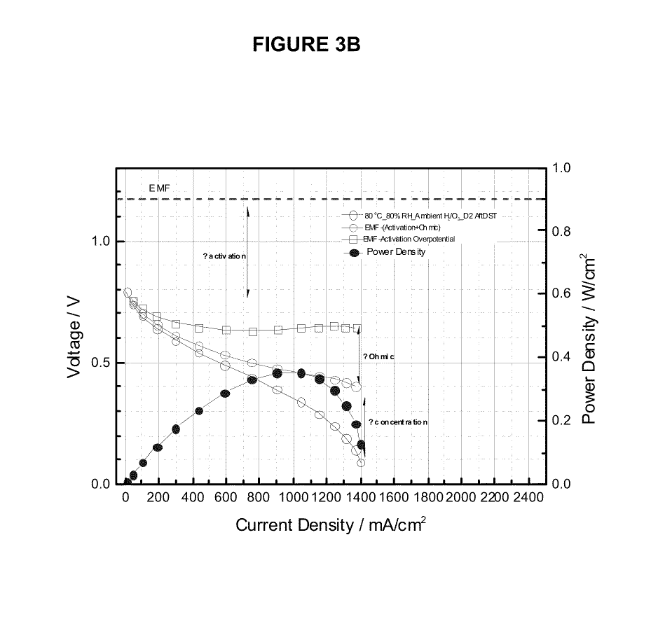

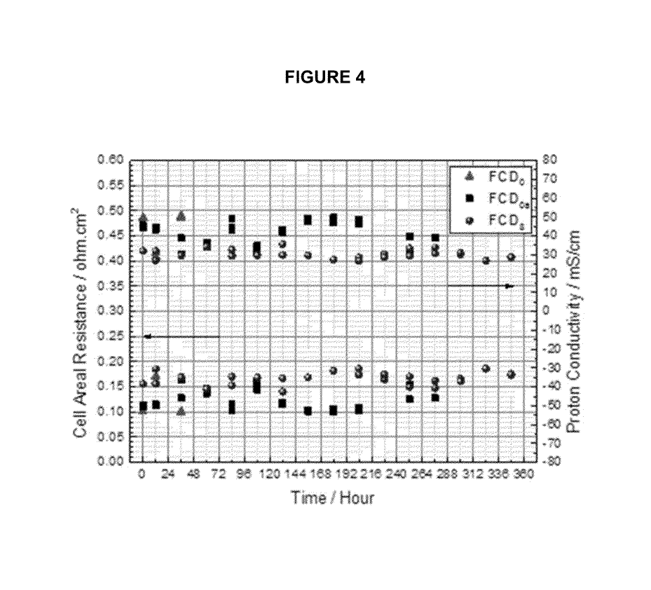

Polarization curves: FIGS. 2 and 3 show such electrodes performance (before (A) and after (B) 250 hrs. of operation) and with ((polymer mix FCD8) FIG. 3), and without ((polymer mix FCD0a) FIG. 4) incorporating the hydrophobic cage structured material in the MEA. In some embodiments, the current potential plots for electrodes without the siloxane (FCD0a) exhibited good initial performance (FIG. 2A), but precipitously dropped in performance after 48 hrs. as seen in FIG. 2B. For example, the peak power density dropped from 0.366 w/cm² to 0.11 w/cm2 after 250 hrs. of uses. In contrast, siloxane containing electrode (FCD8) exhibited significantly higher peak power, 0.604 W/cm² and then dropped to 0.33 W/cm² during the same period of use (see FIGS. 3A and 3(B) respectively).

### Example 2

Conductivity measurements: FIG. 4 shows areal resistance values for fuel cells made by embodiments of the methods herein described. The plot compared three similar fuel cells, that comprise polymers with differing compositions and properties. The polymer FCD0a comprises 0% OSP, and the polymer FCD8 comprises 3 wt. % OSP, and 97% Nafion. In some embodiments, resistance values for the cells range from 0.09 to 0.19 0 cm2, which correspond to proton conductivity values ranging from 25 to 52 mS/cm. FCD0 is an MEA identical in composition to FCD0a that failed after 48 hours of operation and has initial resistance was similar to FCD0a. In some embodiments, due to the presence of OSP in the membrane of FCD8, a marginally higher areal resistance, and lower proton conductivity values were observed as compared to those of FCD0 and FCD0a. According to the profile produced over 250 hours, the membrane resistance and proton conductivity of FCD8 showed little variation; however, the resistance and proton conductivity (H⁺) values did change for the pure Nafion membranes contain MEAs of FCD0 and FCD0a and eventually approached that of FCD8 which contains only 3 wt. % OSP to Nafion in all components. The values of areal resistance, and H⁺ conductivity indicate that the cell performance drop of FCD0a may be thus be attributed to the mass transport issue associated with water flooding rather than membrane degradation.

### Example 3

Evidence of Elimination of Flooding and Cell Testing Procedure:

In some embodiments, MEA's made by the methods herein described were assessed for the effects of water flooding by a long time durability testing, and the dynamic load cycling protocol established by the U.S. Department of Energy (DOE) was thus used to assess the long-term performance of PEMFC cells under conditions reflecting situations encountered in the automotive. The test protocol involves cyclically stepping through a series of currents with periodic interruption of the cycling for polarization measurements and diagnostics. The various steps in the dynamic load test protocol were defined by the measured current densities at the specified cell voltages obtained in the initial cell polarization measurement. The initial stack polarization curve was used to establish the current steps for the load test profile at stack voltages of 8.8, 8.0, 7.5, 6.5, and 6.0 V.

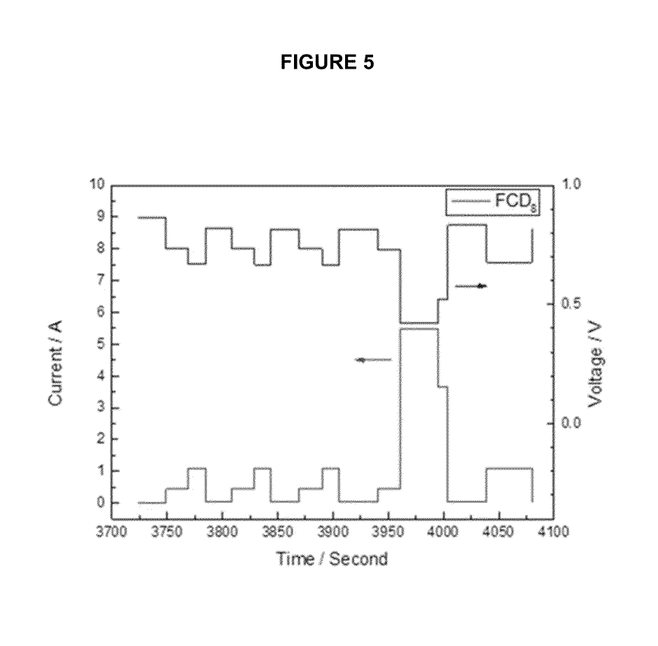

The current values at these voltages for FCD8 are illustrated in FIG. 5, and were generated from initial cell performances. The dynamic load cycling was conducted on both FCD0a and FCD8 for 250 hours total with Duty-On 12 hours and Duty-Off 12 hours per day. The cell set-up and test protocols are described below:

A) Cell Start-up (Pre Conditioning): 1) set purge gas/(fuel and oxidant) flow rate to 0.2 L/min and start sending purging gas; 2) set cell operation temperature at 80° C. and start heating up cell; 3) maintain the system (heating up the cell while purging the cell) for five minutes; 4) set humidifier temperatures at 75° C. and start heating up humidifiers; 5) maintain the system under this condition for two minutes; 6) start sending fuel (H₂) and oxidant (O₂) through anode and cathode, respectively; 7) maintain the system under this condition for one minute; and 8) Operate the cell at 0.65 V for two minutes.

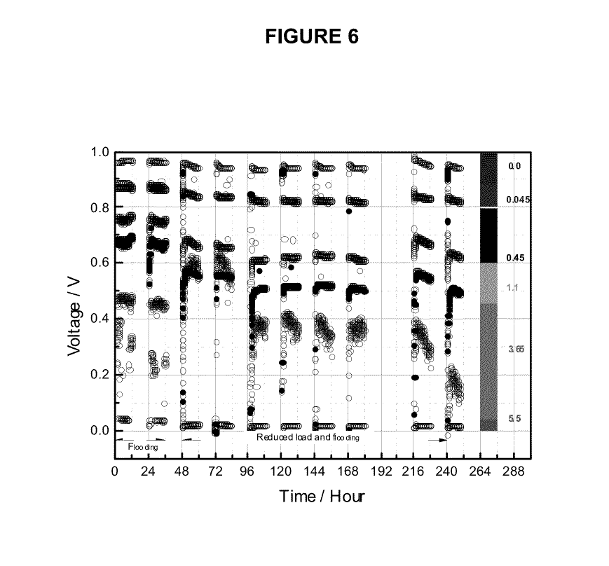

During the 12 Hours Operational, Duty-On Period: the DST program used 367 seconds per cycle and 118 cycles, which is equivalent to approximately 12 hours of total duty on operation. Single cells were operated at 80° C. with around 80% relative humidity (humidifiers at 75° C.) with 0.2 L/min H₂ and O₂ as fuel and oxidant. The cell was operated at 16 different constant current conditions over a period of 367 seconds, as shown in FIG. 6, during a single cycle of DST, the cell shutdown protocol (prior to cell off period) comprises: 1) turn off fuel and oxidant flow to the cell and start sending purging gas; 2) turn off humidifier heaters; 3) maintain the system for three minutes; 4) turn off cell heaters; 5) maintain the system under this condition for seven minutes; and 6) turn off purging gas.

Further, during Duty-Off Period: a test cell of an MEA made by an embodiment of the method herein described, was isolated from all the gases, loads, and heating for a period of 700 minutes, wherein the time of 700 minutes (with non-operational time, during shutdown and start-up) makes total non-operational time equal to 12 hours.

In order to confirm the flooding problem associated with some PEMCs (of the prior art) especially at higher current densities, the above DST was conducted on both FCD0a and FCD8 under the same set operating conditions for 250 hours. FIG. 6 clearly demonstrates the voltage profile of FCD0a MEA during a 250 hours DST testing, a large voltage fluctuation especially at voltage values at current above 3.65 A is observed, but a relatively stable voltage is observed at current lower than 3.65 A for the rest 250 hours measurements. The estimated voltage drop rate values at current of 1.1, 0.45, and 0.045 A were 0.72, 0.64, 0.32 mV/h, respectively.

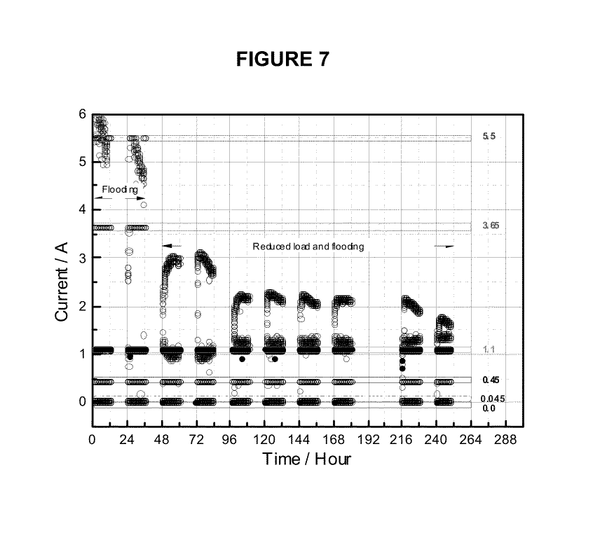

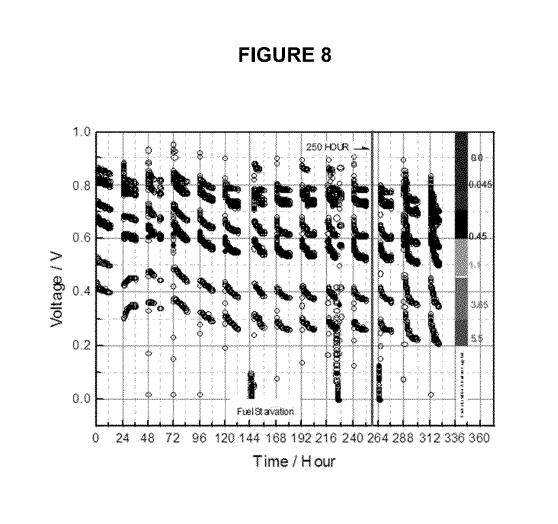

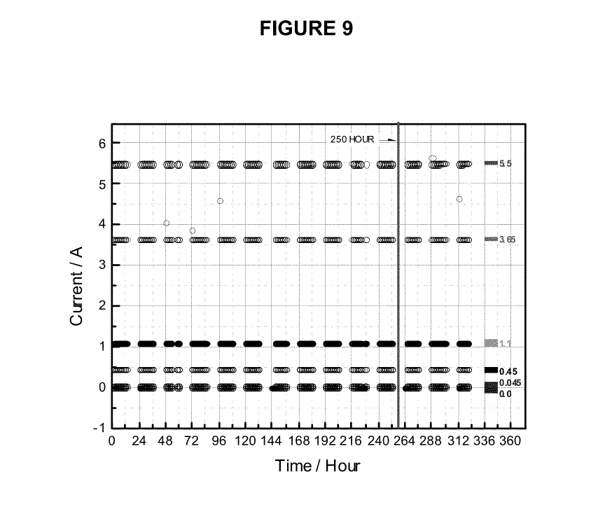

To verify the mass transportation issue caused by water flooding, data was analyzed with desired/applied current load (FIG. 7) to confirm the voltage drop which occurred during DST operation (presented in FIG. 6). The current response over the whole range of time as presented in FIG. 7 is consistent with the voltage response presented in FIG. 6. The load retort in FIG. 7 at current of 3.65 and 5.5 A could not possibly be achieved due to a significant flooding problem generated with FCD0a during full scale DST operation, which can be seen in the 1st and 2nd 12 hour Duty-On period of FIG. 7 causing unstable current. In contrast to FCD0a in FIG. 6, OSP containing MEA, FCD8 described herein, (FIG. 8) shows much lesser fluctuation in voltage and did not show any water flooding at even the highest current of 5.5 A during 250 hours DST study. A negligible vertical voltage drop can be seen in FIG. 8 (under 0.2V) for FCD8 MEA, which is ascribed to fuel starvation before fuel completely breaks-in in the cell. Further, the voltage profile of FCD8 MEA in FIG. 8 during 250 hours DST experiment in some embodiments did not show degradation, where estimated voltage drop rate values at current of 5.5, 3.65, 1.1, 0.45, and 0.045 A were 0.36, 0.3, 0.32, 0.28, 0.27 mV/h, respectively. FIG. 9 is the current variation plot with time of DST experiment conducted on FCD8 which contains OSP in MEA. This plot clearly demonstrates applied load at currents of 3.65 and 5.5 A, which are in close agreement with the voltage plot in FIG. 8. Both FIGS. 8 and 9 suggest that there is no water flooding issue, thus mass transportation issues may not exist within MEA's comprising a hydrophobic-cage like material such as OSP.

Furthermore, evidence of the different degree of standing water in various components of cells made with and without OSP can be seen by visual inspection, as clearly illustrated in FIGS. 10 and 11. Large water marks and water accumulation can be observed in the flow-field (left) of FIG. 10, confirming that flooding occurred during 250 hours of DST operation on FCD0a (0% OSP). It is well established and herein confirmed that flooding is a serious issue in PEMFCS (and low temperature fuel cells in general), causing water accumulation between GDL and flow-field layers, and thus blockage of the pores of the GDLs and electrodes as expected. In contrast, there was no sign of water either in the flow-field or on the GDL surface of FCD8 made in accordance with the methods herein described, and observed in FIG. 11. In both cases (FCD0a and FCD8), photographs were taken immediately after disassembling cells after completing a 250 hours DST operation.

The embodiments described above provide a method of making MEA's that comprise hydrophobic cage-structured materials that clearly mitigate the effect of water flooding in such MEA's and resultant fuel cells, and thus cells that comprise such MEA's are clearly functionally more robust that cells that do not comprise MEA's made by the methods herein described, and therefore provide a method of producing MEA'S that mitigate mass transport issues and water flooding, that are clearly needed and an improvement over some known MEA's and fuel cells.

While exemplary embodiments have been shown and described, modifications thereof can be made by one skilled in the art without departing from the scope or teachings herein. The embodiments describe herein are exemplary only and are not limiting. Many variations and modifications of the systems, apparatus, and processes described herein are possible and are within the scope of the invention as claimed below. Accordingly, the scope of protection is not limited to the embodiments described herein, but is only limited by the claims that follow, the scope of which shall include all equivalents of the subject matter of the claims.

What is claimed is:

1. A method of making an electrode that mitigates water flooding, comprising:
1) mixing a hydrophobic cage structured material with a solvent, and adding to a first polymer to form a first polymer mixture;
2) mixing a carbon support metal catalyst, and at least a first polymer mixture to form a second mixture;
3) mixing the second mixture to form a catalyst ink;
4) spraying the catalyst ink at a first catalyst loading onto a gas diffusion layer (GDL), wherein said gas diffusion layer may be optionally treated with a hydrophobic material; and
5) drying said catalytic ink onto said GDL to form an electrode, wherein said electrode mitigates water flooding

2. The method of claim 1, wherein said electrode is porous, and comprises said hydrophobic cage material, wherein said material is dispersed throughout the electrode to reduce water flooding in said electrode.

3. The method of claim 1, wherein said hydrophobic cage structured material is a silsesquioxane compound.

4. The method of claim 1, wherein said hydrophobic cage structured material is OSP.

5. The method of claim 1, wherein said solvent is THF.

6. The method of claim 1, wherein said first polymer is an ionomer.

7. The method of claim 1, wherein said first polymer is Nafion.

8. The method of claim 1, wherein said metal catalyst is Pt.

9. The method of claim 1, wherein said catalyst loading is about 0.2 mg Pt/cm².

10. The method of claim 1, wherein said catalyst loading is about 0.25 mg Pt/cm².

11. The method of claim 1, wherein said catalyst ink comprises:
1) about 20% Pt/C; and
2) about 20% of said first polymer mixture, wherein said first polymer mixture comprises, 97% wt of said first polymer and about 3% wt of said hydrophobic cage structured material.

12. The method of claim 1, wherein said drying is by air, at about 103 degrees Celsius for about 1 hr.

13. The method of claim 12, wherein said mixing of said ink comprises:
1) stirring for about 30 minutes;
2) sonicating for about 30 minutes; and
3) further stirring for about 30 minutes.

14. A method of making an apparatus comprising an electrode, wherein the electrode comprises a hydrophobic cage structured material, wherein the method comprises:
1) mixing a hydrophobic cage structured material with a solvent, and adding to a first polymer to form a first polymer mixture;
2) mixing a metal catalyst and a carbon support, and at least a first polymer mixture to form a second mixture;
3) mixing the second mixture to form a catalyst ink;
4) spraying the catalyst ink at a first catalyst loading onto at a first gas diffusion layer to form a first catalyst layer of a first electrode;
5) spraying the catalyst ink at a second catalyst loading optionally different from the first catalyst loading, onto at second gas diffusion layer side to form a second catalyst layer of a second electrode; and
6) assembling said first and said second electrodes with a membrane layer to comprise an membrane electrode assembly, wherein the first and second electrode mitigates water flooding.

15. The apparatus of claim 14, wherein said apparatus performance is improved compared to apparatus without a hydrophobic cage-structured polymer.
